(19) United States
(12) Patent Application Publication
(10) Pub. No.: US 2017/0188033 A1
(43) Pub. Date: Jun. 29, 2017

(54) Method and Apparatus of Bandwidth Estimation and Reduction for Video Coding

(71) Applicant: MEDIATEK INC., Hsin-Chu (TW)

(72) Inventors: Hsiu-Yi LIN, Taichung City (TW); Ping CHAO, Taipei City (TW); Ming-Long WU, Taipei City (TW); Chia-Yun CHENG, Zhubei City (TW); Chih-Ming WANG, Zhubei City (TW); Yung-Chang CHANG, New Taipei City (TW)

(21) Appl. No.: 15/386,011

(22) Filed: Dec. 21, 2016

Related U.S. Application Data
(60) Provisional application No. 62/387,276, filed on Dec. 23, 2015.

(51) Int. Cl. H04N 19/159; H04L 12/26; H04N 19/433; H04N 19/96; H04N 19/91

(52) U.S. Cl. CPC H04N 19/159; H04N 19/96; H04N 19/91; H04N 19/433; H04L 43/0894

(57) ABSTRACT

A method and apparatus of reusing reference data for video decoding are disclosed. Motion information associated with motion vectors for coded blocks processed after the current block are derived without storing decoded residuals associated with the coded blocks. Reuse information regarding reference data required for Inter prediction or Intra block copy of the coded blocks is determined based on the motion information. If the current block is coded in the Inter prediction mode or the Intra block copy mode, whether required reference data for the current block are in an internal memory is determined and the reference data are fetched from an external memory to the internal memory if the required reference data are not stored in the internal memory. The reference data in the internal memory is managed according to the reuse information to reduce data transferring between the external memory and the internal memory.

### CROSS REFERENCE TO RELATED APPLICATIONS

The present invention claims priority to U.S. Provisional Patent Application, Ser. No. 62/387,276, filed on Dec. 23, 2015. The U.S. Provisional Patent Application is hereby incorporated by reference in its entirety.

### FIELD OF THE INVENTION

The present invention relates to video coding using Inter prediction mode or Intra block copy mode. In particular, the present invention relates to method and apparatus to improve reference data reuse efficiency so as to reduce system bandwidth requirement.

### BACKGROUND AND RELATED ART

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC, VP8, VP9 and the emerging HEVC (High Efficiency Video Coding) standard. In order to maintain manageable complexity, an image is often divided into blocks, such as macroblock (MB) or coding unit (CU) to apply video coding. Video coding standards usually adopt adaptive Inter/Intra prediction on a block basis.

Adaptive Inter/Intra video coding has been widely used in various video coding systems. The system may divide a picture into blocks and a block may be coded in an Inter mode or an Intra mode. For Inter-prediction, motion estimation and motion compensation are used to select one or more reference blocks from one or more previously reconstructed reference pictures. When the Intra mode is used, previously reconstructed video data in the same picture are used to derive a predictor. The residuals between a current block and its predictor are generated. The residuals often are coded using transformation (e.g. discrete cosine transform, DCT) and quantization to form quantized transform coefficients. A scanning pattern is used to scan through the two-dimensional quantized transform coefficients and convert them into coded symbols. The symbols corresponding to quantized transform coefficients are encoded into bitstream. The bitstream is included in the final video bitstream along with other associated information (e.g., motion information related motion estimation).

FIG. 1 illustrates an exemplary block diagram of a video decoder with adaptive Inter/Intra prediction. The video bitstream is received by the variable length decoder (VLD) 110 to decode the bitstream into coded symbols corresponding to coded residuals and various coding information (e.g. motion vector). The coded residuals are processed by inverse scan (IS) 112 to convert the one-dimensional quantized coefficients into two-dimensional quantized coefficients, which is further processed using inverse quantization (IQ) 114 and inverse transform (IT) 116 to recover the residuals 117. To reconstruct the pixel value, the residuals are added to the prediction data 119 using an adder 118. The prediction data 119 is provided by Inter/Intra selection unit 120, which selects Intra prediction data from Intra prediction 122 or Inter prediction data from motion compensation unit 124. The motion compensation unit 124 requires motion vector (MV) information in order to access corresponding reference data stored in the decoded picture buffer 128. Accordingly, MV calculation unit 126 is used to extract and derive needed MV information. The output from the adder corresponds to reconstructed pixel data 121. In order to alleviate the coding artifacts in the reconstructed picture, deblocking filter 130 is often used. Additional loop filters may also be used in advanced coding system. The filtered reconstructed video data are stored in the decoded picture buffer 128 for display or as reference data for Inter prediction of other pictures.

As shown in FIG. 1, the filtered reconstructed video data are stored in the decoded picture buffer 128. Reference data for Inter prediction are read from the decoded picture buffer 128. For bi-prediction, each block is predicted by two reference blocks and therefore, two blocks have to be accessed from the decoded picture buffer. Furthermore, when fractional-pel MV is used, additional pixel data around the reference block may have to be accessed in order to perform interpolation. Accordingly, the memory bandwidth associated with reference data access for Inter prediction may be very high. With the trend of ever-increasing video resolution, the required memory bandwidth could impose a formidable challenge to video decoder systems.

In order to conserve memory bandwidth related to reference data access, internal storage can be used to store reference data that are expected to be frequently used. In this case, the reconstructed data are fetched from the system storage to the internal reference storage. Therefore, the reference data that are expected to be reused can be retrieved from internal memory instead of repeatedly retrieved from external memory that causes memory bandwidth consumption. The internal reference storage is usually implemented in cache memory that operates in a higher speed than the system storage. Since the internal reference storage has a higher unit cost, the size of the internal reference storage is typically much smaller than that he size of the system storage.

In recent years, techniques to address Intra frame redundancy using an Intra frame block vector to locate a reference block in the previously coded region of the current picture have been disclosed. For example, Intra block copy (IntraBC or IBC) has been disclosed for HEVC-based screen content coding. The IntraBC mode works in a similar fashion as the Inter prediction mode. However, Inter prediction uses a previously coded picture as the reference data while IntraBC prediction uses a coded region of a currently coded picture as the reference data. IntraBC prediction may use the same architecture as the Inter prediction to perform motion estimation/compensation by treating the block vector as a motion vector. Accordingly, the block vector is also called the motion vector in this disclosure.

When the memory bandwidth usage exceeds the memory bandwidth limit, the decoder performance may drop rapidly. The use of internal reference storage helps to reduce the memory bandwidth requirement. To address the issue carefully, it needs a more precise estimate of the memory bandwidth usage. Accordingly, it is desirable to develop techniques to estimate the memory bandwidth more precisely and techniques to reduce the memory bandwidth.

### BRIEF SUMMARY OF THE INVENTION

A method and apparatus of reusing reference data for video decoding are disclosed. The decoder receives a video bitstream corresponding to coded video data comprising a current block and pre-decodes, from the video bitstream, motion information associated with a set of motion vectors for one or more coded blocks without storing decoded residuals associated with the coded blocks. Each motion vector represents displacement vector for one block coded in Inter prediction mode or Intra block copy mode. The coded blocks are coded after the current block. Reuse information regarding reference data required for Inter prediction or Intra block copy of the coded blocks is determined based on the motion information associated with the set of motion vectors. If the current block is coded in the Inter prediction mode or the Intra block copy mode, whether required reference data for the current block are in an internal memory is determined and the reference data are fetched from an external memory to the internal memory if the required reference data are not stored in the internal memory. The reference data in the internal memory is managed according to the reuse information to reduce data transferring between the external memory and the internal memory.

Managing the reference data in the internal memory according to the reuse information may comprise increasing life time for target reference data to stay in the internal memory if the reuse information indicates that the target reference data is expected to be used by the coded blocks. Determining the reuse information regarding reference data required for Inter prediction or Intra block copy for the coded blocks comprises determining long-term data reuse and short-term data reuse. The long-term data reuse is for first reference data reused among the coded blocks from different macroblock (MB) rows or CTU (coding tree unit) rows and the short-term data reuse is for second reference data reused among said one or more coded blocks in a same MB row or CTU row. The internal memory comprises L1 cache memory and L2 cache memory, the long-term data reuse for the first reference data are stored in the L2 cache memory, and the short-term data reuse for the second reference data are stored in the L1 cache memory.

The reuse information regarding memory address of the required reference data is derived using the motion information comprising reference frame index and coordinate, memory address, decoding block index with or without a corresponding motion vector, or any combination thereof. The reuse information regarding memory address of the required reference data comprises referenced times and index for each reference data region to be used by the coded blocks, weighting indication regarding length of time to be retained in the internal memory for each reference data region, or any combination thereof.

The video decoder may apply entropy decoding to recover coded residual data associated with the coded blocks and apply simple entropy encoding to re-encode the coded residual data for storage.

In one embodiment, the reuse information regarding the reference data required for the Inter prediction or Intra block copy of the coded blocks can be stored in the external memory after the reuse information is determined. The reuse information regarding the reference data required for the Inter prediction or Intra block copy of the coded blocks from the external memory for use by the step of managing the reference data in the internal memory. In another embodiment, the motion information associated with the set of motion vectors is stored in the external memory after the motion information associated with the set of motion vectors is pre-decoded. The motion information is retrieved from the external memory for use by the step of determining the reuse information.

In yet another embodiment, comprising the video decoder determines estimated bandwidth required for accessing the reference data from the external memory based on the reuse information. System configurations are then adjusted according to the estimated bandwidth. In another embodiment, the motion information is provided directly to the step of determining the estimated bandwidth without storing to the external memory after the motion information is pre-decoded. The step of adjusting the system configurations comprises adjusting a working voltage or a working frequency of at least one processor or unit of the video decoder for power saving, adjusting storage arbitration priority to improve access efficiency, releasing high priority to other functional component that has more critical bandwidth requirement than the reference data, or a combination thereof. The information regarding the estimated bandwidth required for accessing the reference data from the external memory can be stored in the external memory.

The video decoder may comprise an external memory for storing data including reference data, a video decoder kernel, a look-ahead MV (motion vector) decoder and a MV analyzer. The look-ahead MV decoder is coupled to the external memory to receive video bitstream. The look-ahead MV decoder decodes motion information associated with a set of motion vectors for one or more coded blocks without storing decoded residuals associated with the coded blocks. Each motion vector represents displacement vector for one block coded in Inter prediction mode or Intra block copy mode, and the coded blocks are coded after the current block. The MV analyzer determines reuse information regarding reference data required for Inter prediction or Intra block copy of the coded blocks based on the motion information associated with the set of motion vectors. The video decoder is configured to cause currently decoder block to be stored in the internal memory. The video decoder is also configured to manage the reference data in the internal memory according to the reuse information to reduce data transferring between the external memory and the internal memory. The decoder may further comprise a bandwidth estimation unit to estimate bandwidth required based on the reuse information for accessing the reference data from the external memory.

### BRIEF DESCRIPTION OF THE DRAWINGS

FIG. 1 illustrates an exemplary block diagram of a video decoder with adaptive Inter/Intra prediction.

FIG. 2 illustrates an example of short-term data reuse and long-term data reuse.

FIG. 3 illustrates an example of long-term reference data reuse. Macroblock A is located at block location (x, y). Macroblocks B and C are located at (x−1, y+1) and (x, y+1) in the next MB row respectively.

FIG. 4 illustrates an example of system functional blocks related to MV analysis and reuse of reference data.

FIG. 5 illustrates the issue associated with enlarged MV pipeline buffer size.

FIG. 6 illustrates an example of key components associated with a video coding system incorporating reference data reuse according to an embodiment of the present invention.

FIG. 7 shows MV pre-decoding includes two functional parts: one occurring in the look-ahead MV decoder 710 and one occurring in the video decoder kernel 720.

FIG. 8 illustrates an example of MV pre-decoding according to an embodiment of the present invention.

FIG. 9A illustrates an exemplary system architecture incorporating MV pre-decoding according to an embodiment of the present invention.

FIG. 9B illustrates an exemplary system architecture incorporating MV pre-decoding according to another embodiment of the present invention.

FIG. 9C illustrates an exemplary system architecture incorporating MV pre-decoding according to yet another embodiment of the present invention, where look-ahead MV decoder can also use external memory as MVD/info buffer between the VLD 920 and MV decoder 520, and between transcoder 922 and simple VLD 926.

FIG. 9D illustrates an alternative system similar to FIG. 9C, where look-ahead MV decoder can also use external memory as MV buffer as well as info buffer for transcoded residual data.

FIG. 10 illustrates an example of bandwidth estimation according to the reused and non-reused reference data.

FIG. 11 illustrates an exemplary system architecture incorporating motion vector analyzer and bandwidth estimation according to first embodiment of the present invention.

FIG. 12A illustrates a flowchart of pre-decoding motion vector in look-ahead MV decoder for the architecture in FIG. 11.

FIG. 12B illustrates an exemplary flowchart of reference data management in the decoder kernel for the architecture in FIG. 11.

FIG. 13 illustrates an exemplary system architecture incorporating motion vector analyzer and bandwidth estimation according to second embodiment of the present invention.

FIG. 14A illustrates a flowchart of pre-decoding motion vector in look-ahead MV decoder in FIG. 13.

FIG. 14B illustrates an exemplary flowchart of reference data management in the decoder kernel for the architecture in FIG. 13.

FIG. 15 illustrates an exemplary system architecture incorporating motion vector analyzer and bandwidth estimation according to third embodiment of the present invention.

FIG. 16 illustrates an exemplary flowchart of associated with the motion vector analyzer and the bandwidth estimation unit for the architecture in FIG. 15.

FIG. 17 illustrates an exemplary system architecture incorporating motion vector analyzer and bandwidth estimation according to fourth embodiment of the present invention.

FIG. 18 illustrates an exemplary flowchart for the bandwidth estimation process based on the architecture of FIG. 17.

FIG. 19 illustrates the flowchart for the reuse information derivation based on the architecture of FIG. 17.

FIG. 20 illustrates an exemplary system architecture incorporating motion vector analyzer and bandwidth estimation according to fifth embodiment of the present invention.

FIG. 21 illustrates an exemplary flowchart of reference data management in the video decoder kernel of FIG. 20.

FIG. 22 illustrates an exemplary system architecture incorporating motion vector analyzer and bandwidth estimation according to sixth embodiment of the present invention.

FIG. 23 illustrates the flowchart for the functions related to reference data management within the video decoder kernel of FIG. 22.

FIG. 24 illustrates an exemplary flowchart for a system using reuse information related to reference data for Inter prediction or Intra bloc copy to minimize data transfer from an external memory to an internal memory according to an embodiment of the present invention.

FIG. 25 illustrates an exemplary flowchart for a system using estimated bandwidth to adjust system configurations according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention discloses a method to improve reference data reuse for memory bandwidth reduction by analyzing the motion vectors and reusing reference data. The reference data reuse can be among macroblocks (MB) rows or coding tree unit (CTU) rows for long-term data reuse. In order to analyze motion vectors efficiently, embodiments of the present invention pre-decodes motion vectors. The motion vectors analyzed include motion vectors for blocks coded in the Inter mode and Intra block vector (IBV) for blocks coded in the Intra block copy (IntraBC or IBC) mode as defined in the HEVC Screen Content Coding. The memory bandwidth estimate is performed before motion compensated decoding.

The reference data reuse can be classified as short-term data reuse and long-term data reuse. The short-term data reuse is referring to data reuse among neighboring MB or CTU in the same MB or CTU row. The long-term data reuse is referring to data reuse among different MB or CTU rows. FIG. 2 illustrates an example of short-term data reuse and long-term data reuse. The macroblocks in a current picture 210 are being decoded in a row-by-row scan order. Macroblocks A and B are in a same MB row and macroblock C in a below MB row. The reference blocks Ref_A, Ref_B and Ref_C in reference picture 220 for macroblocks A, B and C are identified using motion vectors MV_A, MV_B and MV_C respectively. As shown in FIG. 2, the reference blocks may be overlapped. For example, reference blocks Ref_A and Ref_B include an overlapped area 222. In other words, the reference data in the overlapped area are retrieved for macroblock A decoding as well as for macroblock B decoding. Furthermore, the reuse of reference data in area 222 within a relatively short period between blocks within a same MB row or CTU row. Accordingly, the reference data reuse for this case is referred as short-term reference data reuse. The reference blocks Ref_B and Ref_C also include an overlapped area 224. The reference data in the overlapped area are retrieved for macroblock B decoding as well as for macroblock C decoding. Furthermore, the reuse of reference data in area 224 is between blocks in different MB rows or CTU rows. Therefore, the reference data reuse for this case is referred as long-term reference data reuse.

Long-Term Data Reuse Scheme

One aspect of the present addresses long-term data reuse. In the method of long-term reuse according to the present invention, the motion compensation (MC) process reads the motion vectors of MB(x, y) through MB(x+u, y+v) before or after MC process reads reference data of a given MB(x, y) from the external memory, where MB(x, y) corresponds to a macroblock at block location (x, y), u is from −L to M, v is from 1 to N, and L,M,N are integers that can be variables to be set during runtime or fixed parameters. While macroblocks are used as example, other block coding block structure such as coding tree unit (CTU) may also be used. After the MVs are read, the motion vectors are analyzed to find one or multiple overlap regions between reference blocks. The MV analyzing process includes following steps: (a) calculating the reference region based on motion vector and other information for each MB; (b) translating the reference regions from pixel unit to access unit (depending on external memory structure); (c) for one or more of MB (x+u, y+v), u=−L to M, v=1 to N, calculating the overlap regions between the reference regions of MB(x, y) and MB(x+u, y+v), and then calculating the union of all overlapped regions. After MVs are analyzed, the method derives reuse information for all or partial of the overlapped regions. According to the reuse information, the method stores all or partial reference data into an on-chip memory. For the external memory, in order to increase access efficiency, the data are often accessed according to a pre-defined unit, i.e., access unit. For example, the access unit may correspond to 256 bytes.

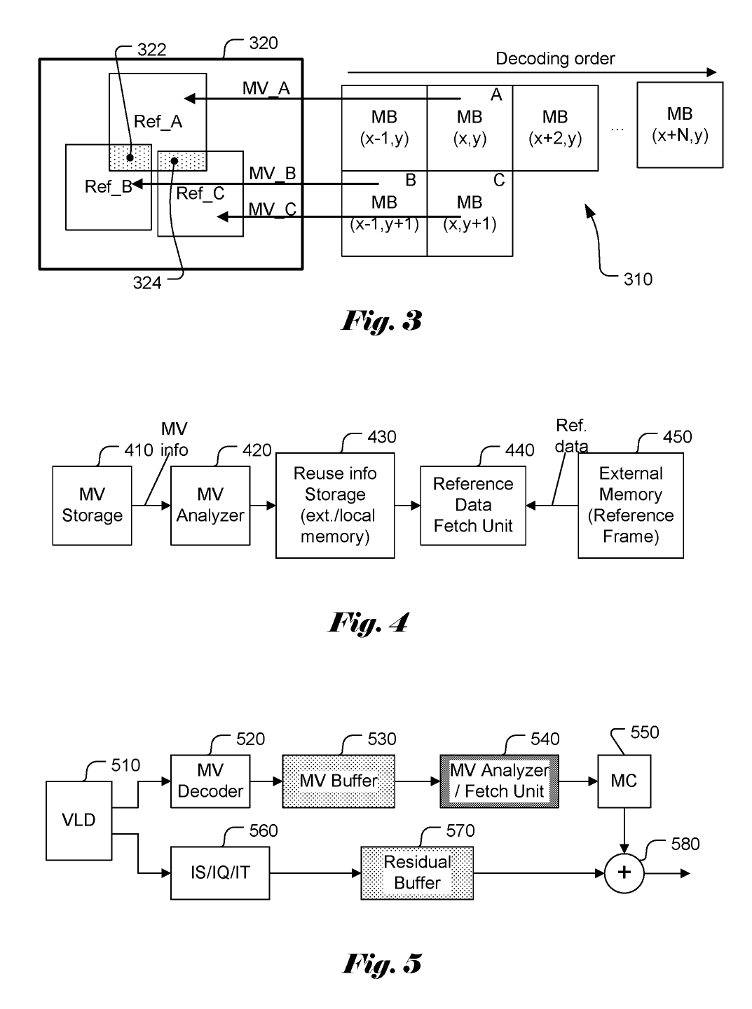

FIG. 3 illustrates an example of long-term reference data reuse. Macroblock A is located at block location (x, y). Macroblocks B and C are located at (x−1, y+1) and (x, y+1) in the next MB row respectively. The associated MVs (MV_A, MV_B and MV_C) are analyzed to determine the overlapped regions. The overlapped region 322 between Ref_A and Ref_B and the overlapped region 324 between Ref_A and Ref_C can be identified. According to embodiments of this method, the reused data for the next few MBs and the reused data for next MB row should be kept in the on-chip memory for different times, where reused data is kept in on-chip memory for a short time for the next few MBs and reused data is kept in the on-chip memory for a longer time for the next MB row. For example, the reference data 322 in the overlap between Ref_A and Ref_B and the reference data 324 in the overlap between Ref_A and Ref_C should be kept in the on-chip memory for the whole MB-row decoding period. Accordingly, prior to reading reference frame data from the external memory for MC to reconstruct prediction data, the present method loads the overlapped reference data to the on-chip memory from the external memory. Therefore, MC process reads the overlapped reference data from the on-chip memory instead of external memory. Consequently, this method eliminates repeatedly external memory access for the overlapped data.

Long-Term Data Reuse Scheme: MV Analysis

A MV analyzer can be used in the same stage or in one stage or multi-stage pipeline before the reference frame fetch unit. The image unit for the pipeline stage can be multiple blocks/MBs/CTUs, a block/MB/CTU row, a slice, a whole picture or multiple pictures. In general, a higher level of pipeline stage can achieve better external memory access reduction, and more accurate bandwidth consumption estimation. More MVs may also be used for MV analysis. However, this approach will require a larger MV buffer size. The MV analyzer reads MVs of one or more blocks from the MV storage, where the MVs in the MV storage are derived from the video bitstream. The MV analyzer may also include the function of deriving the MVs from the bitstream instead of relying on other processing units to derive the MVs and store them in the MV storage. Overlapped regions of reference block are analyzed based on the MVs for short-term reuse, long-term reuse, or both. The reuse information is then sent to the reference frame fetch unit for fetching reference data from the external memory to the on-chip memory in order to reduce the external memory access for motion compensation process.

FIG. 4 illustrates an example of related functional blocks for a video decoding system incorporating MV analysis and reuse reference data derivation according to an embodiment of the present invention. MV information are retrieved from MV storage 410 and provided to the MV analyzer 420. The MV analyzer 420 determines the reuse information based on the MV information. The reuse information is stored in the reuse information storage 430, which is provided to the reference data fetch unit 440 for fetching reference data from reference frame buffer stored in external memory 450. The reuse information storage 430 may be in external memory or local memory. The reference data fetch unit 440 fetches the reused reference data and stores the reused reference data in an on-chip (i.e., internal) memory, which is not shown in FIG. 4.

In FIG. 4, the reuse information is derived by the MV analyzer. The reuse information may include a coordinate or index that can be used to derive the final memory address to access the required reference frame data. The coordinate or index can be the reference frame index and coordinate, memory address, or decoding block index (with/without MV). The reuse information may also include one or a combination of the following information for each or a group of coordinate/address/block-index information: (a) referenced times and index of decoding block, and (b) weighting. The referenced times and index of decoding block can be used to indicate which decoding block and how many times that the reference region will be referenced. The weighting may correspond to a number or a single-bit flag to represent the time that the reference region should be kept in the local memory. For example, the weighting may correspond to 0, 1 and 2, where 0 means no need to reuse, 1 means the short-term reuse, and 2 means long-term reuse. In another example, the weighting may correspond to n, n=0 to 10, where n means to keep the reference region for n μs.

Reference Data Reusing: Architecture

In order to get enough MVs to analyze and derive reuse information for long-term data reuse, it is necessary to enlarge MV pipeline buffer between MV module and MC module. For example, MV pipeline buffer size can be larger than one MB row. However, if the MV pipeline buffer is enlarged, pipeline buffer for residual data or other pipeline buffer on the data path from VLD to residual may also have to be enlarged, which may require several times of size needed for the MVs. FIG. 5 illustrates the issue associated with the enlarged MV pipeline buffer size. Both MVs and residuals are derived from the variable length decoder (VLD) 510 using MV decoder 520 and inverse scan (IS)/inverse quantization (IQ) and inverse transform (IT) 560 respectively. The MV analyzer and reference data fetch unit 540 is used to fetch needed reference data for motion compensation 550. The prediction data from MC 550 is added to the residuals from residual buffer 570 using adder 580 to form the reconstructed pixel data. Without special care, both the MV buffer 530 and the residual buffer 570 will be enlarged. However, the decoded residuals after inverse scan (IS)/inverse quantization (IQ) and inverse transform (IT) 560 become very large. Therefore, while the system shown in FIG. 5 helps to reduce memory bandwidth related to reference data, it causes substantial increase in storage for residual data. Accordingly, a pre-decoding method is disclosed to reduce the buffer requirement for the residual data. In the above discussion, while MB is used as an example, it is understood that other block structure such as CTU may also be used.

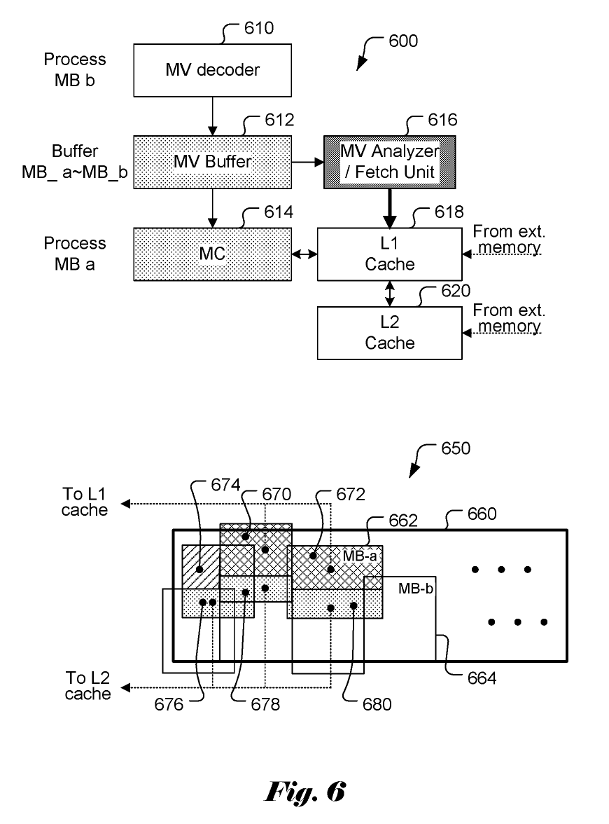

FIG. 6 illustrates an example of key components 600 associated with a video decoding system incorporating reference data reuse according to an embodiment of the present invention. The key components include MV decoder 610, MV buffer 612, motion compensation unit 614, MV analyzer/fetch unit 616, L1 cache 618 and L2 cache 620. The MV analyzer/fetch unit 616 controls data fetching from the external memory (not shown in FIG. 6) to on-chip memory, where the on-chip memory comprises L1 cache 618 and L2 cache 620. The reference data stored in L1 cache 618 and L2 cache 620 are used by the motion compensation unit 614. The reference data usage 650 is also shown in FIG. 6 for a reference picture 660, which is stored in an external memory. The example shows the processing of these macroblocks by the processing pipeline. Macroblock MB_a 662 is currently being processed by motion compensation unit 614. The MV decoder 610 processes macroblock MB b 664 in a following MB row. The motion vectors for the currently processed macroblock MB_a through macroblock MB b in a following MB row are stored in the MV buffer 612. The MV analyzer/fetch unit 616 determines the reference data reuse based on the motion vectors stored in the MV buffer 612. The MV analyzer/fetch unit 616 identifies some reference data as candidates for placing in L1 cache for short-term reuse and some reference data as candidates for placing in L2 cache for long-term reuse. In this example, reference data regions 670 and 672 are identified for short-term reuse for placing into L1 cache. The reference data region 674 that was previously in the L1 cache and will be flushed when macroblock MB_a is processed by the MC 614. In this example, reference data regions 676, 678 and 680 are identified for long-term reuse for placing into L2 cache.

Motion Vector Pre-Decoding

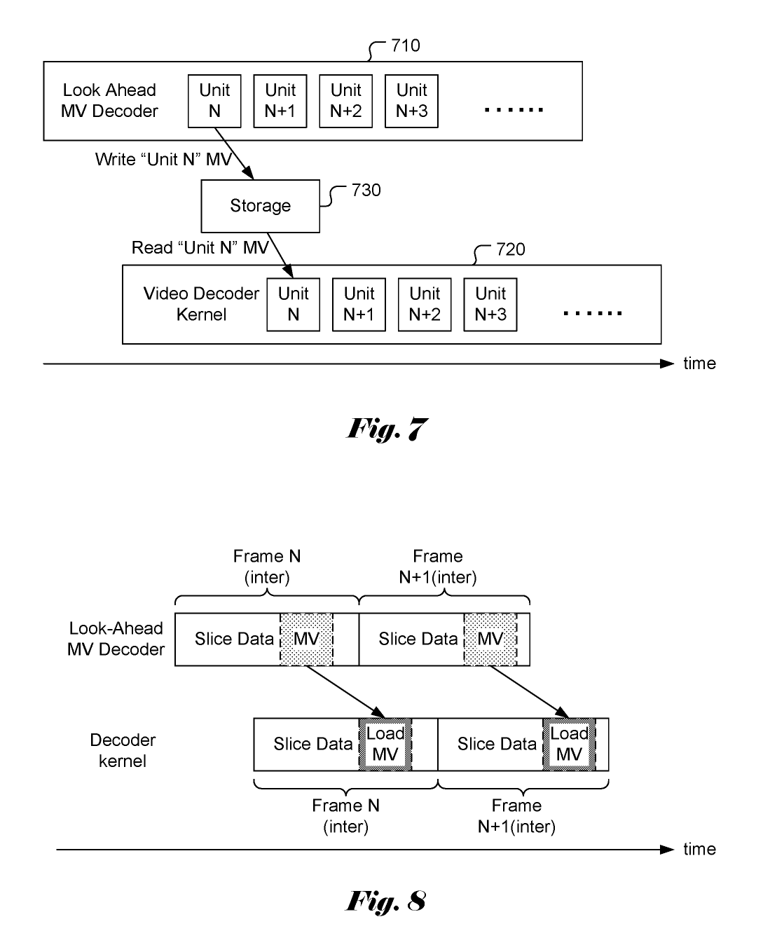

In order to solve the issue associated with increased residual buffer, embodiments of the present invention use MV pre-decoding so that the number of MVs buffered is increased without the need for noticeably increasing the amount of residuals. MV pre-decoding includes two functional parts: one occurring in the look-ahead MV decoder 710 and one occurring in the video decoder kernel 720 as shown in FIG. 7. At the look-ahead MV decoder, motion vectors are decoded and written into storage 730. At the video decoder kernel, motion vectors are read from the storage. The look-ahead MV decoder and the video decoder kernel are configured to have a set of MVs for units (e.g. blocks) N through (N+k) pre-decoded and stored in the storage when the video decoder kernel is processing unit N, where k is a positive integer. The unit may correspond to a picture, slice, MB row, CTB row, MB, block or any other image unit for processing.

FIG. 8 illustrates an example of MV pre-decoding according to an embodiment of the present invention. MV pre-decoding is performed at the frame level so that all MVs in a frame are pre-decoded and saved separately from slice data associated with residuals. The decoder kernel loads MVs for the whole-frame.

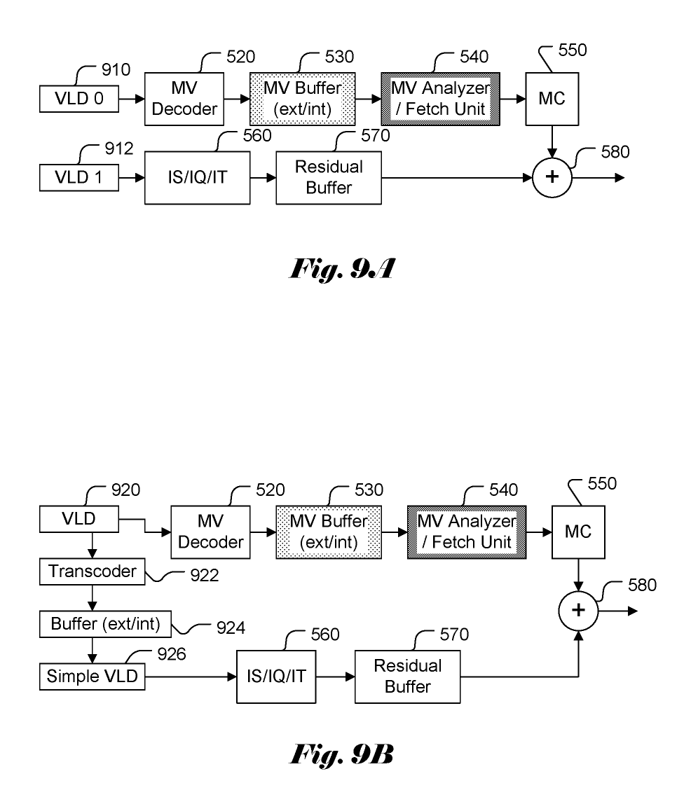

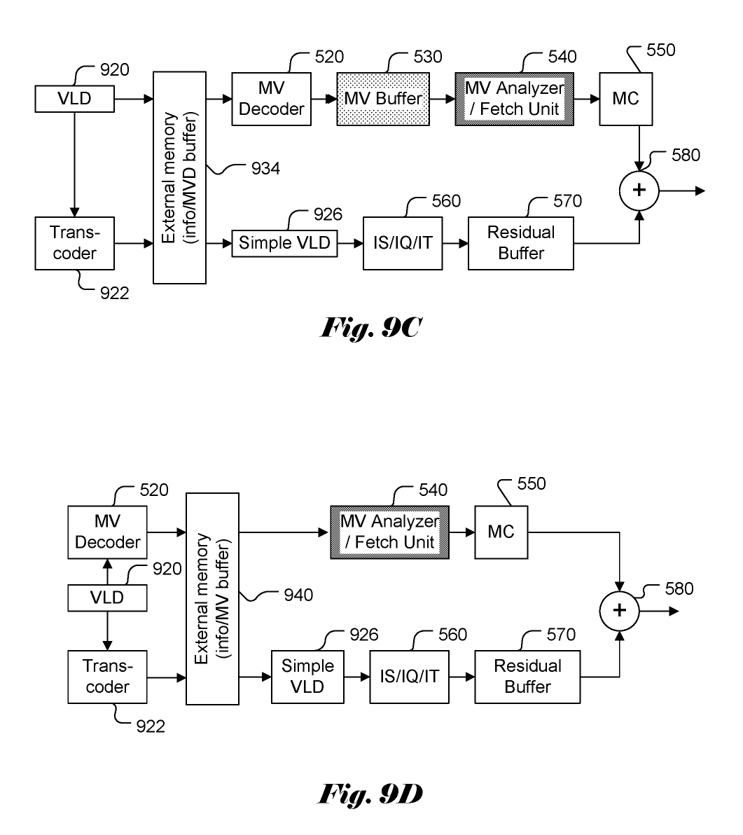

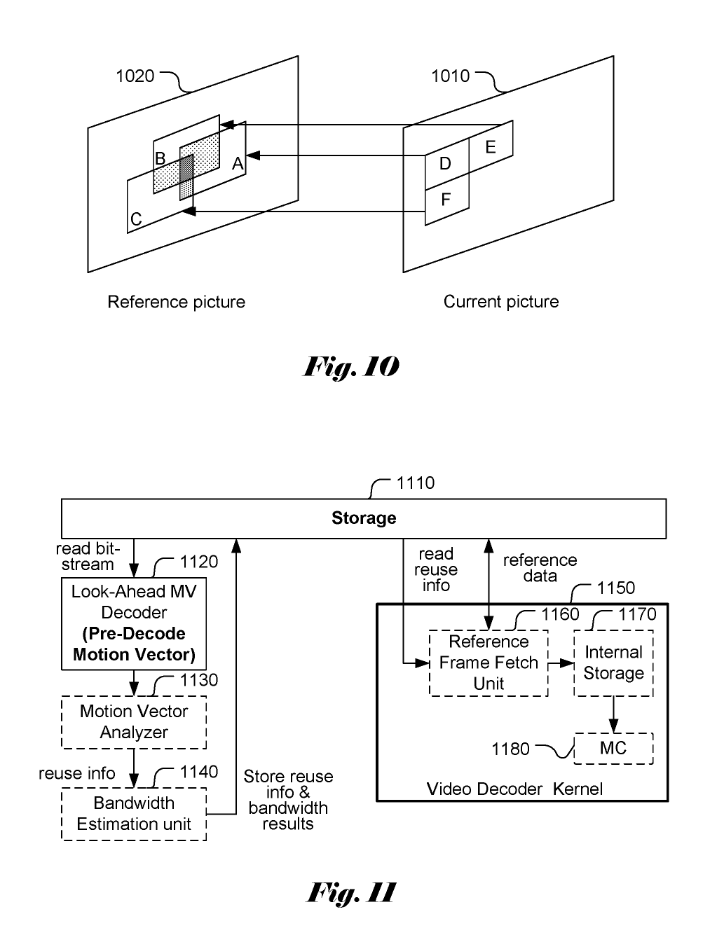

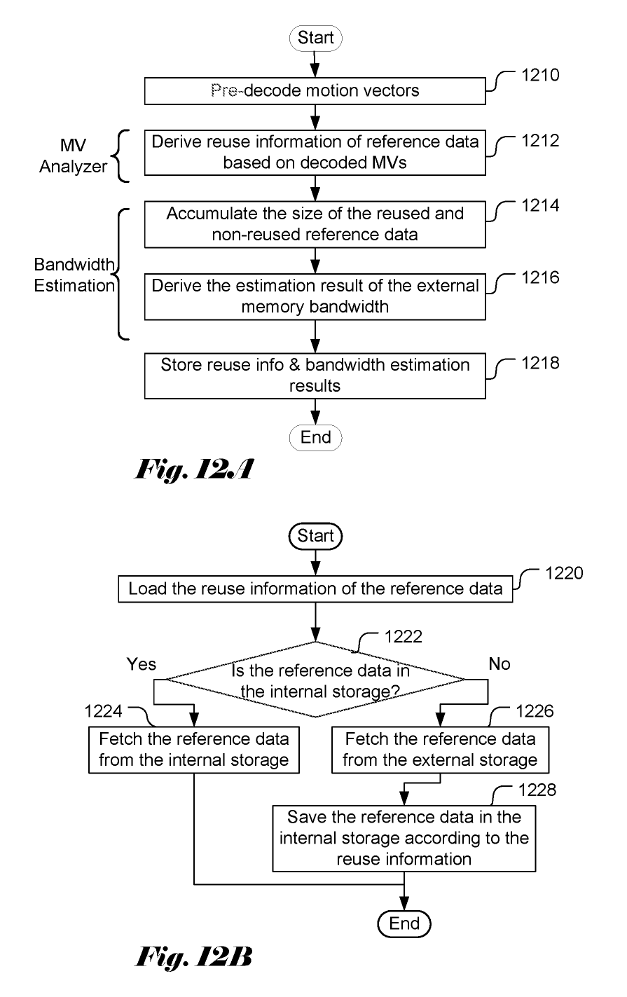

FIG. 9A illustrates an exemplary system architecture incorporating MV pre-decoding according to an embodiment of the present invention. The architecture is similar to that in FIG. 5. However, independent MV path and IS/IQ/IT path are used in FIG. 9A, where the two paths have their own VLDs (910 and 912). VLD 0 (910) and MV decoder 520 perform the MV pre-decoding function.

FIG. 9B illustrates an exemplary system architecture incorporating MV pre-decoding according to another embodiment of the present invention, where a fully functional VLD 920 and a simple VLD 926 with a transcoder 922 are used so the pipeline depth between the two paths can be very deep. After VLD, the size of residual data may become rather large. In order to reduce the required storage space associated with residual data, the VLD-decoded residual data is re-encoded again. However, the coding efficiency may not be the key concern. Accordingly, a simple VLC can be applied to the VLD-decoded residual data to reduce the storage requirement. Accordingly, transcoder 922 is used and a buffer 924 is used to store the transcoded residual data. According to the system in FIG. 9B, MV buffer can pipe more MVs without large size increase of residual buffer. Also, MV analyzer can get more MVs to perform better analysis. Again, combination of MV decoder and its VLD is a “look-ahead MV decoder”.

FIG. 9C illustrates an exemplary system architecture incorporating MV pre-decoding according to yet another embodiment of the present invention, where look-ahead MV decoder can also use external memory as MVD/info buffer between the VLD 920 and MV decoder 520, and between transcoder 922 and simple VLD 926. Since the external memory 934 has a larger capacity, there may be only one VLD to store the decoded coefficient and info for IS/IQ/IT in the external memory in order to achieve the two-path decoding as the two VLD architectures.

FIG. 9D illustrates another alternative system similar to FIG. 9C, where look-ahead MV decoder can also use external memory as MV buffer as well as info buffer for transcoded residual data.

Motion Vector Analyzer

The motion vector analyzer analyzes the distribution of the reference data in the decoding unit based on the pre-decoded motion vectors. Reuse information of reference data can be derived to help the decoding system to reduce external memory access. With the known reuse information, the decoding system can reduce memory access accordingly. Alternatively, the decoding system can estimate external memory bandwidth consumption according to the MV and/or reuse information. This function will exploit reuse information, which is derived from MV analyzer or itself, to calculate the size of external memory access caused by the reference data.

Bandwidth Estimation

This function will exploit reuse information, which is derived from MV analyzer or the reuse information itself. The bandwidth estimation is calculated based on the size of external memory access caused by the reference data. The bandwidth estimation results can be applied to adjust the system configurations, such as the working voltage for power saving, the working frequency for power saving, or the storage arbitration priority to improve the accessing efficiency or release the high priority to other functional component which has more critical bandwidth requirement.

Reuse information can be determined by identifying the reused and non-reused reference data, accumulating the size of the reused and non-reused reference data, or accumulating the size of the reused and non-reused reference data.

FIG. 10 illustrates an example of bandwidth estimation according to the reused and non-reused reference data. The blocks D, E and F in the current picture 1010 refer to the reference blocks A, B and C respectively in the reference picture 1020. The memory bandwidth for blocks D, E and F is the sum of non-reused regions (indicated by block areas of these blocks) in reference blocks A, B and C and the reused regions (indicated by areas filled with dots) in reference blocks A, B and C.

In the following, several system architectures incorporating motion vector analyzer and bandwidth estimation according to embodiments of the present invention are disclosed. However, these examples are intended for illustrative purposes only, and shall not be construed as limitations to the present invention.

### System Architecture: Embodiment 1

FIG. 11 illustrates an exemplary system architecture incorporating a motion vector analyzer and bandwidth estimation unit according to one embodiment of the present invention. The look-ahead MV decoder, motion vector analyzer and bandwidth estimation unit are arranged as separate units from video decoder kernel. The look-ahead MV decoder 1120 reads bitstream from the storage 1110 to pre-decode the MVs. The pre-decoded MVs are then analyzed by motion vector analyzer 1130 to derive reuse information. The bandwidth estimation unit 1140 estimates the required bandwidth. Both the reuse information and the estimated bandwidth are stored in the storage 1110 for later use. The reuse information is stored in the storage and is later retrieved by the video decoder kernel for controlling fetching of reuse reference data from external memory. Accordingly, the video decoder kernel 1150 accesses the reuse information from storage 1110. The reuse information is used by the reference frame fetch unit 1160 to fetch reference data from external storage 1110 to internal storage 1170. The reference data stored in the internal storage are then used for motion compensation (MC) 1180.

In FIG. 11, only the components related to reference data are illustrated. For example, beside the motion compensation unit 1180, the video decoder kernel may also include inverse scan, inverse quantization and inverse transform to reconstruct the residuals so that the motion compensation unit 1180 may add the reconstructed residuals to the reference block to form a reconstructed block. Furthermore, for reference data reuse, the bandwidth estimation unit 1140 may not be needed. In this case, the bandwidth estimation unit 1140 may be eliminated from the decoder system.

FIG. 12A illustrates a flowchart of pre-decoding motion vectors by the look-ahead MV decoder and deriving reuse information and bandwidth estimation. In step 1210, motion vectors are pre-decoded. In step 1212, the reuse information of reference data is derived based on the motion vectors, which is performed by the MV analyzer. The size of the reused and non-reused reference data are accumulated in step 1214. The estimation result of the external memory bandwidth is derived in step 1216. Both steps 1214 and 1216 can be performed by a bandwidth estimation unit. The reuse information and bandwidth results are stored in step 1218.

FIG. 12B illustrates an exemplary flowchart of reference data management in the decoder kernel. The reuse information of the reference data is loaded to the decoder in step 1220. Whether the reference data is in the internal storage is checked in step 1222. If the reference data is in the internal storage (i.e., the “Yes” path), step 1224 is performs. Otherwise (i.e., the “No” path), steps 1226 and 1228 are performed. In step 1224, the reference data is fetched from internal storage. In step 1226, the reference data is fetched from external storage. In step 1228, the reference data is saved in the internal storage according to the reuse information. As mentioned before, the internal memory typically is implemented using a cache memory that a processor (e.g. CPU or video decoder kernel) can access more quickly than it can access from a regular DRAM (dynamic random access memory). The cache memory is typically integrated directly with the CPU or video decoder kernel chip (level-1 (L1) cache) or placed on a separate chip (level-2 (L2) cache) that has a separate bus interconnect with the CPU or video decoder kernel. The case that the reference data for a block being decoded are not in the internal memory corresponds to a “cache miss”. On the other hand, when the needed reference data are in the internal cache memory, it corresponds to a “cache hit”. When the needed reference data are in the internal cache memory, there is no need to access the needed data from external memory. Embodiments of the present invention optimize or substantially increase the cache hits for a given cache size by exploit reference data reuse based on pre-decoded MVs.

As mentioned before, the bandwidth estimation results can be applied to adjust the system configurations, such as the working voltage for power saving, the working frequency for power saving, or the storage arbitration priority to improve the accessing efficiency or release the high priority to other functional component which has more critical bandwidth requirement. Accordingly, the bandwidth estimation results are stored in the memory so that the bandwidth estimation results can be access by other part of the system for desired system control.

While the system shown in FIG. 11 utilizes reuse information to reduce bandwidth required to transfer reference data from the external memory to the internal memory and utilizes the estimated bandwidth to adjust system configurations, a system according to the present invention may utilize reuse information only to reduce bandwidth or utilize the estimated bandwidth only to adjust system configurations.

### System Architecture: Embodiment 2

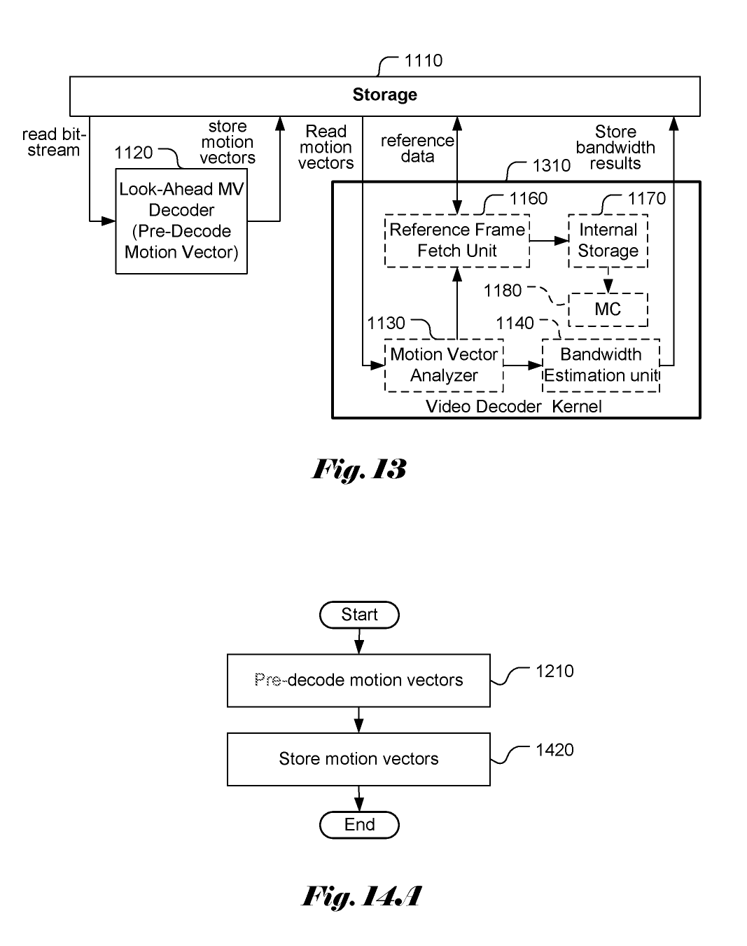

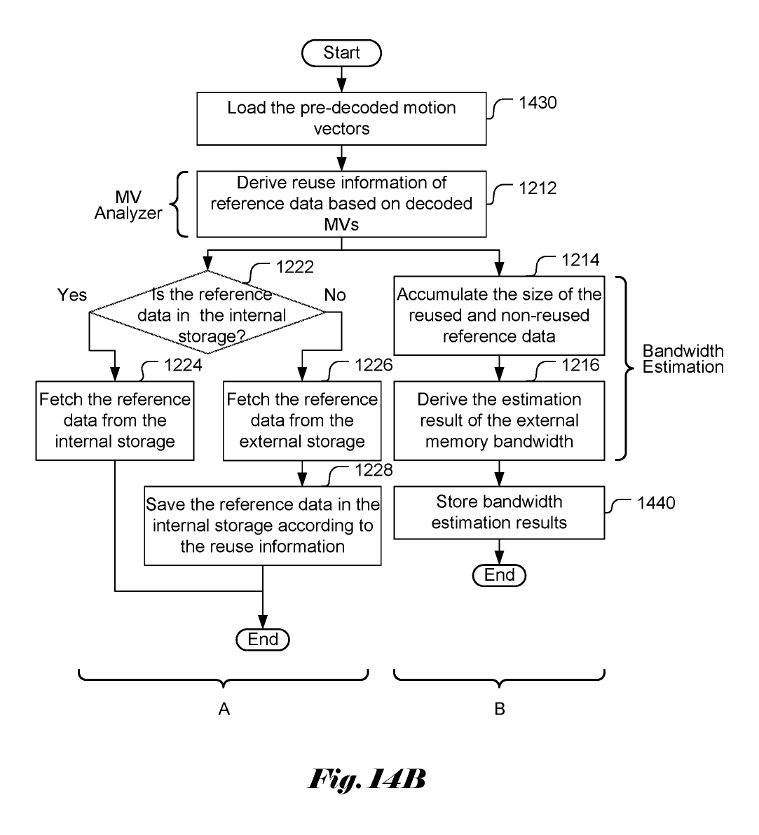

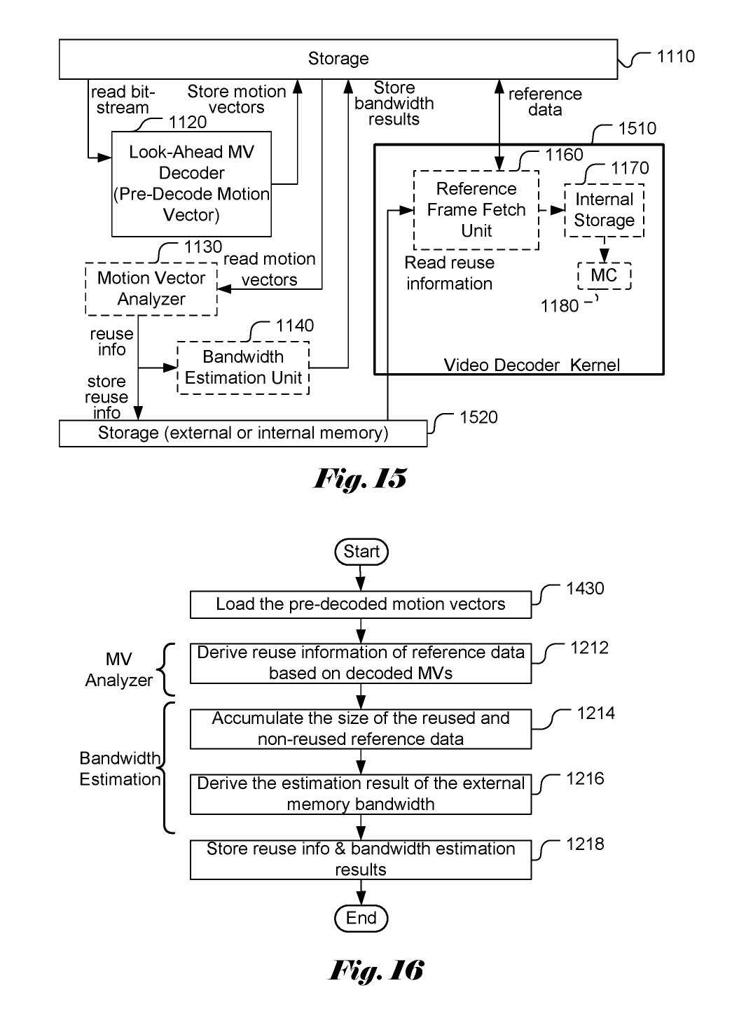

FIG. 13 illustrates an exemplary system architecture incorporating a motion vector analyzer and bandwidth estimation unit according to another embodiment of the present invention. The components of FIG. 13 are the same as those of FIG. 11. However, the components are arranged differently, where the motion vector analyzer 1130 and the bandwidth estimation unit 1140 are located in the video decoder kernel 1310. The look-ahead MV decoder 1120 reads bitstream from the storage 1110 to pre-decode the MVs. The pre-decoded MVs are then saved to the storage 1110.

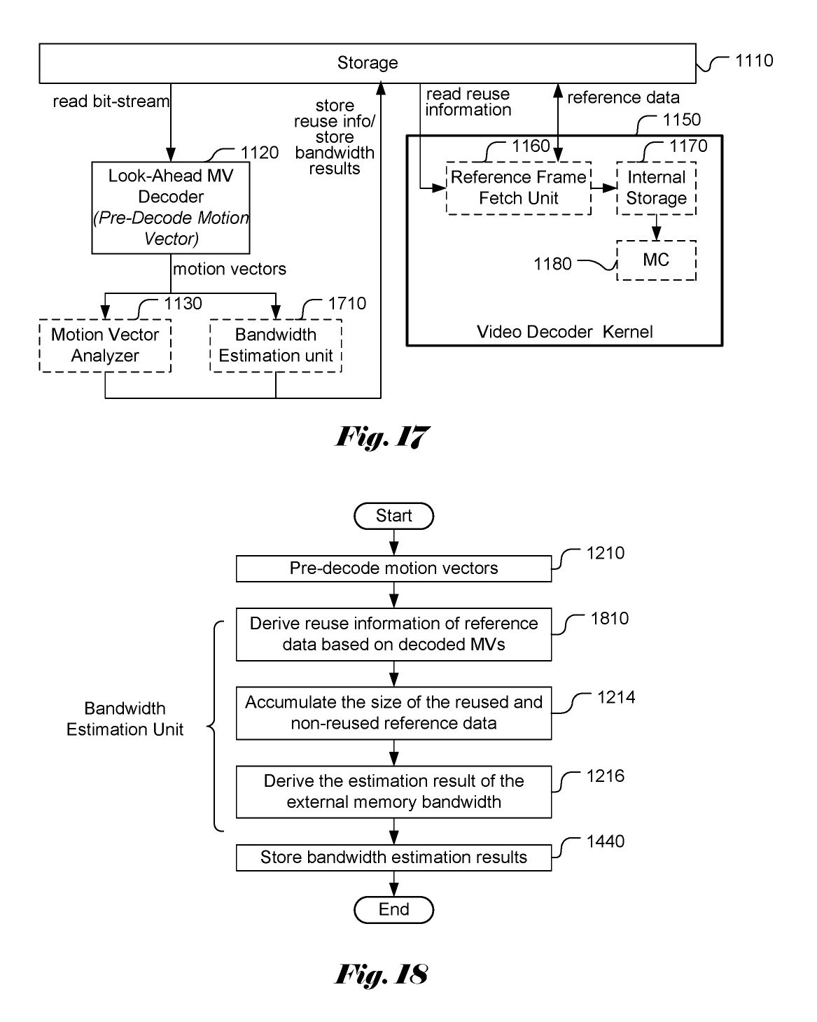

FIG. 14A illustrates a flowchart of pre-decoding motion vector by the look-ahead MV decoder of FIG. 13. In this case, the look-ahead MV decoder pre-decodes motion vector in step 1210 and stores the motion vectors in step 1420.

FIG. 14B illustrates an exemplary flowchart of reference data management in the decoder kernel 1310. Since both the motion vector analyzer 1130 and the bandwidth estimation unit 1140 are located in the video decoder kernel 1310, the flowchart in FIG. 14B includes steps in addition to these of FIG. 12B. The pre-decoded motion vectors are loaded into the video decoder kernel in step 1430. Then, the reuse information of reference data is derived based on motion vectors in step 1212 using the MV analyzer. After step 1212, two branches of activities occur simultaneously, which can be performed separately or jointly. The branch A including steps 1222, 1224, 1226 and 1228 are the same as those in FIG. 12B. Branch B includes bandwidth estimation (steps 1214 and 1216) and storing the bandwidth estimation results in storage (step 1440).

### System Architecture: Embodiment 3

FIG. 15 illustrates an exemplary system architecture incorporating a motion vector analyzer and bandwidth estimation unit according to another embodiment of the present invention. The components of FIG. 15 are the same as those of FIG. 11. However, the components are arranged differently; where the motion vector analyzer 1130 and the bandwidth estimation unit 1140 are separate from the look-ahead MV decoder 1120 and the video decoder kernel 1510. The look-ahead MV decoder 1120 reads bitstream from the storage 1110 to pre-decode the MVs. The pre-decoded MVs are then saved to the storage 1110. Since the look-ahead MV decoder writes the decoded MVs to the storage 1110, the motion vector analyzer needs to retrieve the decoded MVs from storage 1110. The use information derived by the MV analyzer may be stored in a separate storage 1520, which may be either an external memory or an internal memory. However, the reuse information may also be stored in the storage 1110. In the case that the reuse information is stored in the separate storage 1520, the video decoder kernel will retrieve the reuse information from the separate storage 1520. The video decoder kernel is the same as that of embodiment 1 (i.e., FIG. 11). Accordingly, the flowchart of reference data management in the decoder kernel is the same as that in FIG. 12A.

Since the motion vector analyzer 1130 and the bandwidth estimation unit 1140 are separate from the look-ahead MV decoder 1120 and the video decoder kernel 1150, the flowchart associated with the motion vector analyzer 1130 and the bandwidth estimation unit 1140 is shown in FIG. 16. The flowchart of FIG. 16 is substantially the same as that of FIG. 12A except for the first step. In FIG. 12A, the first step corresponds to pre-decoding the motion vectors by the look-ahead MV decoder 1120. Since the look-ahead MV decoder 1120 is separate from the motion vector analyzer 1130 and the bandwidth estimation unit 1140, the first step in FIG. 16 is to load the pre-decoded motion vectors from the storage.

### System Architecture: Embodiment 4

FIG. 17 illustrates an exemplary system architecture incorporating a motion vector analyzer and bandwidth estimation unit according to another embodiment of the present invention. As shown in FIG. 17, both the motion vector analyzer 1130 and bandwidth estimation unit 1710 are coupled to the look-ahead MV decoder 1120 in parallel to receive the decoded MVs. The motion vector analyzer 1130 receives decoded MVs from the look-ahead MV decoder 1120 and generates reuse information. The reuse information is written to the storage 1110 so that the information can be used by video decoder kernel 1150. In this case, bandwidth estimation unit 1710 receives decoded MVs from the look-ahead MV decoder 1120 and generates bandwidth estimation results. Since the reuse information of the reference data are not available, the bandwidth estimation unit has to derive the reuse information by itself. Therefore, the bandwidth estimation unit in FIG. 17 has to perform additional function and the bandwidth estimation unit in FIG. 17 is different from that in FIG. 11. Accordingly, a different reference number “1710” is used to designate this bandwidth estimation unit. The bandwidth results are written into the storage 1110 so that the video decoder system can use the information to adjust working voltage/frequency or adjust storage priority. The video decoder kernel remains the same as that in FIG. 11.

FIG. 18 illustrates an exemplary flowchart for the bandwidth estimation process based on the architecture of FIG. 17. In FIG. 18, the MVs are pre-decoded using the look-ahead MV decoder in step 1210. The reuse information of the reference data is derived based on the decoded MVs in step 1810 by the bandwidth estimation 1710. The size of the reused and non-reused reference data are accumulated in step 1214 and the estimation results of the external memory bandwidth are derived in step 1216. The bandwidth estimation results are then stored in the storage in step 1440. FIG. 19 illustrates the flowchart for the reuse information derivation. The MVs are pre-decoded in step 1210 and reuse information of the reference data are derived based on the decoded MVs in step 1212. The reuse information is then stored in the storage in step 1910.

### System Architecture: Embodiment 5

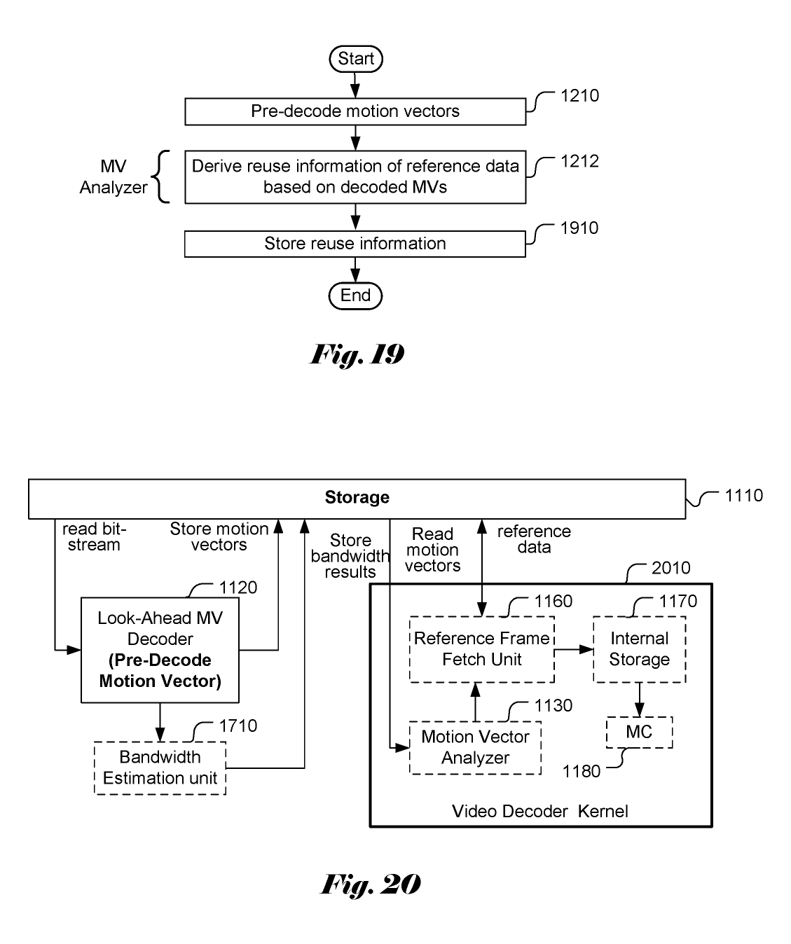

FIG. 20 illustrates an exemplary system architecture incorporating a motion vector analyzer and bandwidth estimation unit according to another embodiment of the present invention. In this example, the motion vector analyzer 1130 is inside the video decoder kernel 2010. Again, since the reuse information of the reference data are not available, the bandwidth estimation unit 1710 has to derive the information by itself.

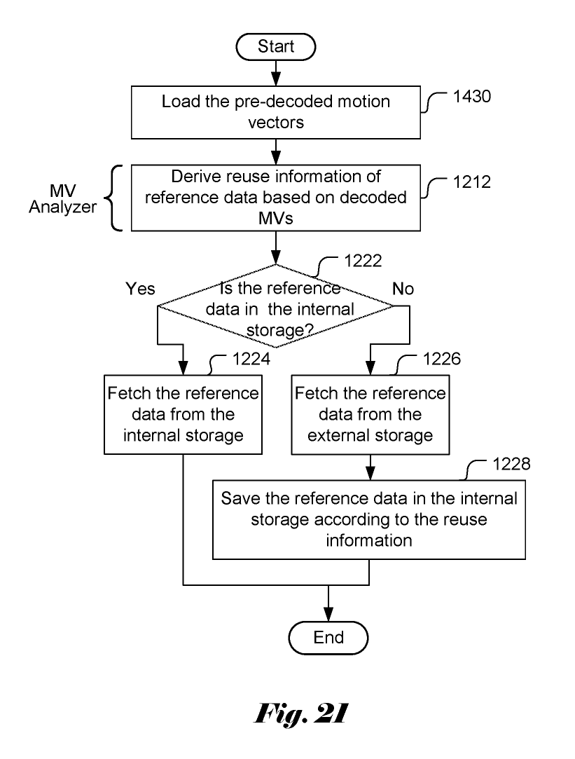

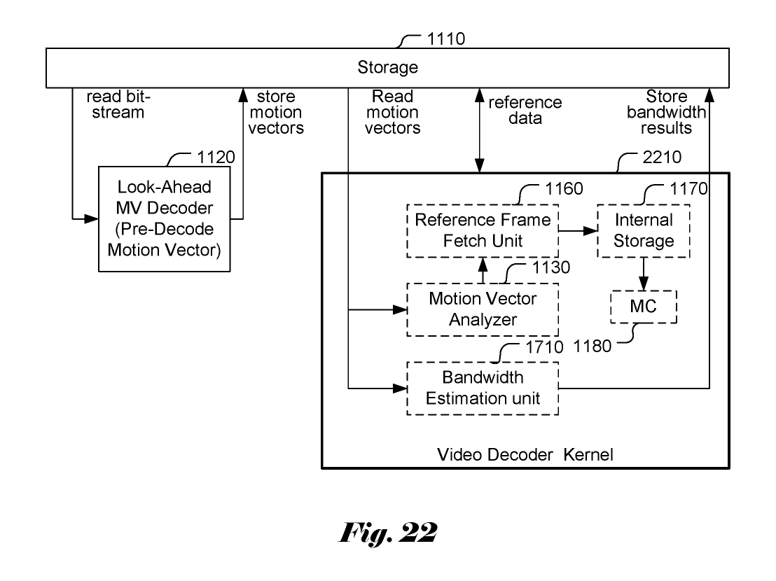

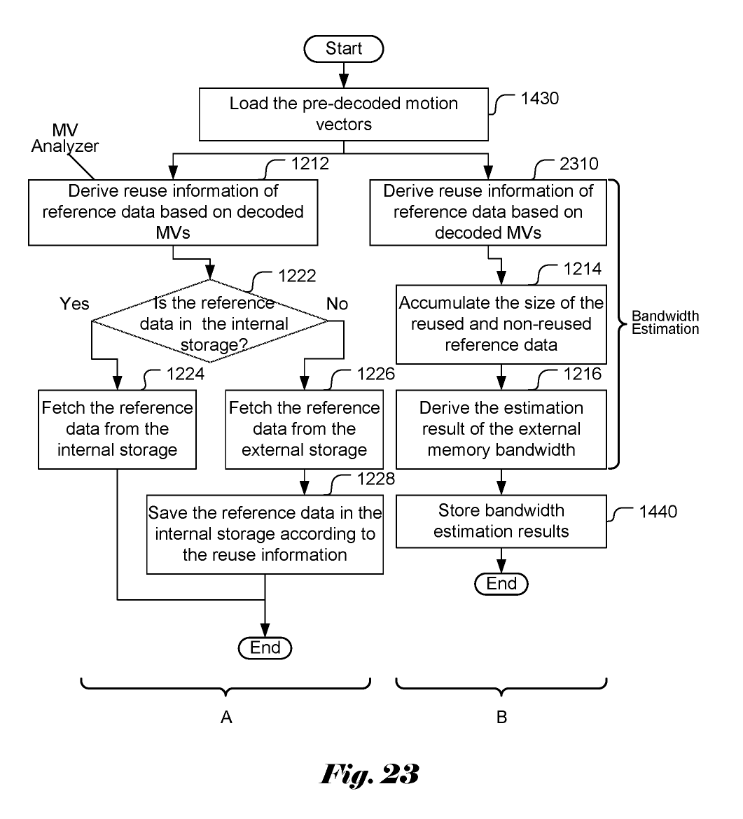

The flowchart for the bandwidth estimation process is the same as that in FIG. 18. FIG. 21 illustrates an exemplary flowchart of reference data management in the decoder kernel. The video decoder kernel 2010 is similar to the video decoder kernel 1310 in FIG. 13 without the bandwidth estimation unit. Therefore, the flowchart of reference data management is similar to that in FIG. 14B. However, since the bandwidth estimation unit is not inside the video decoder kernel 2010, the processing branch B in FIG. 14B is omitted in FIG. 21.

### System Architecture: Embodiment 6

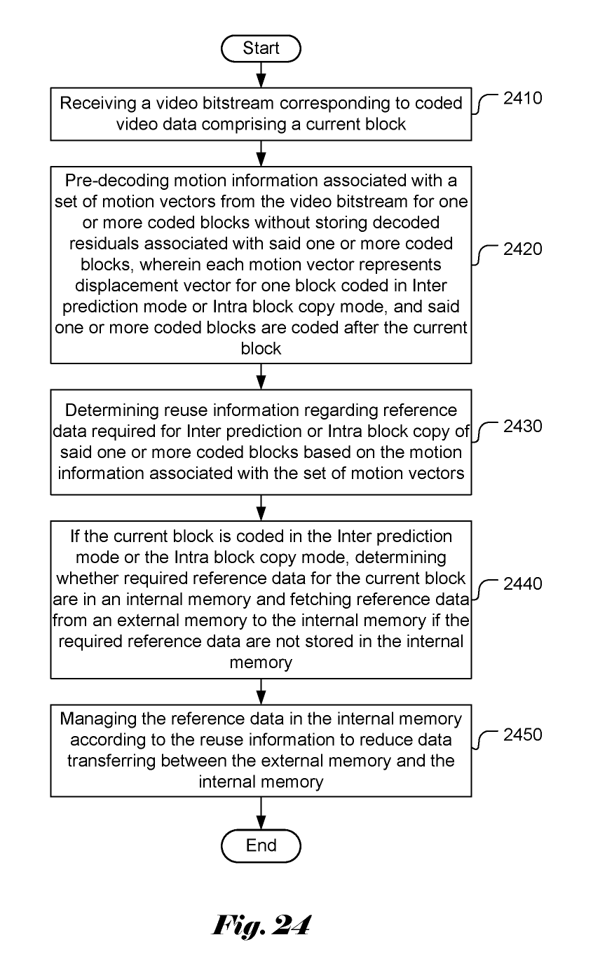

FIG. 22 illustrates an exemplary system architecture incorporating a motion vector analyzer and bandwidth estimation unit according to another embodiment of the present invention. In this example, both the motion vector analyzer 1130 and the bandwidth estimation unit 1710 are inside the video decoder kernel 2210, which is similar to the video decoder kernel 1310 in FIG. 13. However, the motion vector analyzer 1130 and the bandwidth estimation unit 1710 are configured differently. In FIG. 22, both the motion vector analyzer 1130 and the bandwidth estimation unit 1710 are connected in parallel to receive the MVs from the storage. Again, since the reuse information of the reference data are not available, the bandwidth estimation unit 1710 has to derive the information by itself

FIG. 23 illustrates the flowchart for the functions related to reference data management and reuse information and estimated bandwidth derivation within the video decoder kernel 2210. The flowchart is similar to that in FIG. 14B. Derivation of the reuse information of reference data is performed by the MV analyzer (i.e., step 1212). The reuse information is then provided to the reference frame fetch unit 1160. Therefore, the rest of processing flow is the same as the branch A of FIG. 14B. For the bandwidth estimation process, the bandwidth estimation unit has to perform the additional function to derive the reuse information of reference data (i.e., step 2310) and the remaining flow is the same as branch B of FIG. 14B.

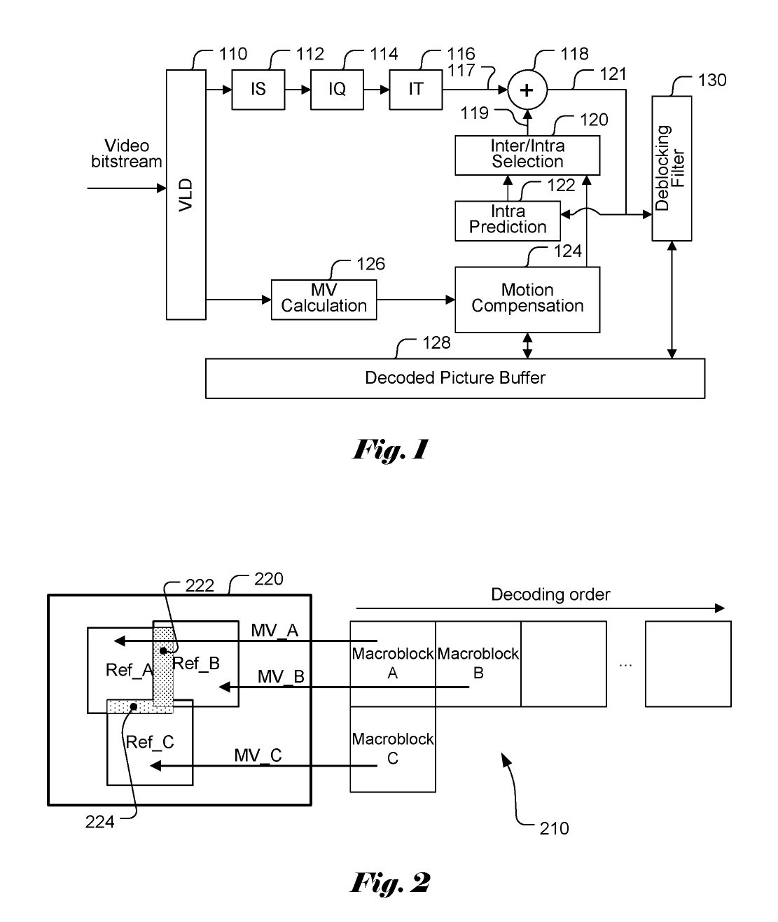

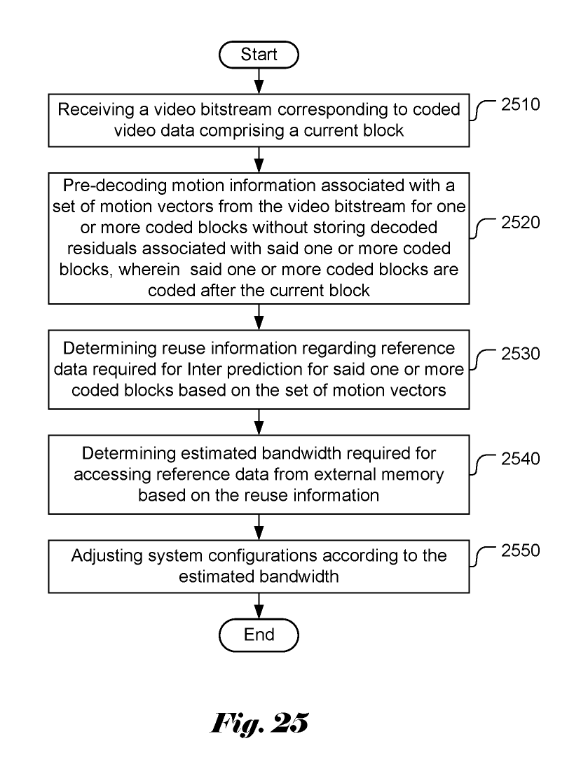

FIG. 24 illustrates an exemplary flowchart for a video decoder using reuse information related to reference data for Inter prediction or Intra block copy to minimize data transfer from an external memory to an internal memory according to an embodiment of the present invention. The system receives a video bitstream corresponding to coded video data comprising a current block in step 2410. As shown in FIG. 1 for a general video decoder, a video bitstream is provided to the video decoder to reconstruct video data. From the video bitstream, motion information associated with a set of motion vectors for one or more coded blocks are pre-decoded without storing decoded residuals associated with said one or more coded blocks in step 2420. As disclosed in various embodiments of the present invention, techniques for MV pre-decoding without storing decoded residuals associated with the coded blocks have been disclosed. For example, FIG. 8 illustrates one embodiment to pre-decode the MVs for a whole frame. The MVs for the frame are collected and inserted into the frame data. On the other hand, the residuals for the slices of the frame stay in a compressed form. FIGS. 9B-C illustrates other examples of MV pre-decoding without storing decoded residuals associated with the coded blocks by applying transcoding to re-encode residuals into a compressed form. Each motion vector represents displacement vector for one block coded in Inter prediction mode or Intra block copy mode, and said one or more coded blocks are coded after the current block. Reuse information regarding reference data required for Inter prediction or Intra block copy of said one or more coded blocks is determined based on the motion information associated with the set of motion vectors in step 2430. Reuse information derivation has been disclosed above. For example, in FIG. 6 and associated description, it discloses the reference data identified for short-term reuse and the reference data identified for long-term reuse. As is known in the field, Inter prediction mode uses reference data from previously coded picture and Intra block copy mode used reference data from previously coded region in the current picture. Therefore, if the current block is coded in the Inter prediction mode or the Intra block copy mode, whether required reference data for the current block are in an internal memory is determined and the reference data are fetched from an external memory to the internal memory if the required reference data are not stored in the internal memory in step 2440. The reference data in the internal memory are managed according to the reuse information to reduce data transferring between the external memory and the internal memory in step 2450. Various reference data management techniques have been disclosed. For example, the reference data management is described in FIG. 12B for the architecture in FIG. 11. According to the present invention, the pre-decoding motion information associated with a set of motion vectors for one or more coded blocks are known when a current block is being decoded. Therefore, these pre-decoded MVs allow the system to estimate the reference data bandwidth requirement for the future blocks more accurately. Systems incorporating embodiments of the present invention are able to determine what reference data are to be used for the future blocks. Accordingly, systems incorporating embodiments of the present invention can result in more efficient reference data memory usage and reduce reference data access.

FIG. 25 illustrates an exemplary flowchart for a system using estimated bandwidth to adjust system configurations according to an embodiment of the present invention. The decoding system receives a video bitstream corresponding to coded video data comprising a current block in step 2510. From the video bitstream, motion information associated with a set of motion vectors for one or more coded blocks processed after the current block are pre-decoded without storing decoded residuals associated with said one or more coded blocks in step 2520. Said one or more coded blocks are decoded after the current block. Reuse information regarding reference data required for Inter prediction for said one or more coded blocks is determined based on the set of motion vectors in step 2530. Estimated bandwidth required for accessing reference data from external memory is determined based on the reuse information in step 2540. Bandwidth estimation based on the reuse information has been disclosed previously in this disclosure. For example, simplified bandwidth estimation is illustrated in FIG. 10. With the pre-decoded MVs, the reuse information for the future blocks can be determined when a current block is being processed. Accordingly, the bandwidth estimation can be determined based on reuse information. The estimated bandwidth is then used to adjust system configurations in step 2550. Various ways to adjust system configurations have been disclosed in this disclosure. For example, the working voltage can be adjusted for power saving; the working frequency can be adjusted for power saving, or the storage arbitration priority can be adjusted to improve the accessing efficiency or release the high priority to other functional component which has more critical bandwidth requirement.

The flowchart shown above is intended to illustrate examples of video coding incorporating an embodiment of the present invention. A person skilled in the art may modify each step, re-arranges the steps, split a step, or combine the steps to practice the present invention without departing from the spirit of the present invention.

The flowcharts in FIG. 24 and FIG. 25 may correspond to software program codes to be executed on a computer, a mobile device, a digital signal processor or a programmable device for the disclosed invention. The program codes may be written in various programming languages such as C++. The flowchart may also correspond to hardware based implementation, where one or more electronic circuits (e.g. ASIC (application specific integrated circuits) and FPGA (field programmable gate array)) or processors (e.g. DSP (digital signal processor)).

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of reusing reference data for video decoding in a video decoder, the method comprising:
receiving a video bitstream corresponding to coded video data comprising a current block;
from the video bitstream, pre-decoding motion information associated with a set of motion vectors for one or more coded blocks without storing decoded residuals associated with said one or more coded blocks, wherein each motion vector represents displacement vector for one block coded in Inter prediction mode or Intra block copy mode, and said one or more coded blocks are coded after the current block;
determining reuse information regarding reference data required for Inter prediction or Intra block copy of said one or more coded blocks based on the motion information associated with the set of motion vectors;
if the current block is coded in the Inter prediction mode or the Intra block copy mode, determining whether required reference data for the current block are in an internal memory and fetching reference data from an external memory to the internal memory if the required reference data are not stored in the internal memory; and
managing the reference data in the internal memory according to the reuse information to reduce data transferring between the external memory and the internal memory.

2. The method of claim 1, wherein said managing the reference data in the internal memory according to the reuse information comprises:
increasing life time for target reference data to stay in the internal memory if the reuse information indicates that the target reference data is expected to be used by said one or more coded blocks.

3. The method of claim 1, wherein said determining the reuse information regarding reference data required for Inter prediction or Intra block copy for said one or more coded blocks comprises determining long-term data reuse for first reference data reused among said one or more coded blocks from different macroblock (MB) rows or CTU (coding tree unit) rows and determining short-term data reuse for second reference data reused among said one or more coded blocks in a same MB row or CTU row.

4. The method of claim 3, wherein the internal memory comprises L1 cache memory and L2 cache memory, the long-term data reuse for the first reference data are stored in the L2 cache memory, and the short-term data reuse for the second reference data are stored in the L1 cache memory.

5. The method of claim 1, wherein the reuse information regarding memory address of the required reference data is derived using the motion information comprising reference frame index and coordinate, memory address, decoding block index with or without a corresponding motion vector, or any combination thereof.

6. The method of claim 1, wherein the reuse information regarding memory address of the required reference data comprises referenced times and index for each reference data region to be used by said one or more coded blocks, weighting indication regarding length of time to be retained in the internal memory for each reference data region, or any combination thereof.

7. The method of claim 1, further comprising applying entropy decoding to recover coded residual data associated with said one or more coded blocks and applying simple entropy encoding to re-encode the coded residual data for storage.

8. The method of claim 1, further comprising:
storing the reuse information regarding the reference data required for the Inter prediction or Intra block copy of said one or more coded blocks in the external memory after the reuse information is determined; and
retrieving the reuse information regarding the reference data required for the Inter prediction or Intra block copy of said one or more coded blocks from the external memory for use by said managing the reference data in the internal memory.

9. The method of claim 1, further comprising:
storing the motion information associated with the set of motion vectors in the external memory after the motion information associated with the set of motion vectors is pre-decoded; and
retrieving the motion information associated with the set of motion vectors from the external memory for use by said determining the reuse information regarding reference data required for the Inter prediction or Intra block copy of said one or more coded blocks.

10. The method of claim 1, further comprising:
storing the motion information associated with the set of motion vectors in the external memory after the motion information associated with the set of motion vectors is pre-decoded;
retrieving the motion information associated with the set of motion vectors from the external memory for use by said determining the reuse information regarding reference data required for the Inter prediction or Intra block copy of said one or more coded blocks;
storing the reuse information regarding the reference data required for the Inter prediction or Intra block copy of said one or more coded blocks in the external memory after the reuse information is determined; and
retrieving the reuse information regarding the reference data required for the Inter prediction or Intra block copy of said one or more coded blocks from the external memory for use by said managing the reference data in the internal memory.

11. The method of claim 1, further comprising determining estimated bandwidth required for accessing the reference data from the external memory based on the reuse information; and adjusting system configurations according to the estimated bandwidth.

12. The method of claim 11, wherein said adjusting the system configurations comprises adjusting a working voltage or a working frequency of at least one processor or unit of the video decoder for power saving, adjusting storage arbitration priority to improve access efficiency, releasing high priority to other functional component that has more critical bandwidth requirement than the reference data, or a combination thereof.

13. The method of claim 11, wherein information regarding the estimated bandwidth required for accessing the reference data from the external memory is stored in the external memory.

14. The method of claim 11, wherein the motion information associated with the set of motion vectors is provided directly to said determining the estimated bandwidth without storing to the external memory after the motion information associated with the set of motion vectors is pre-decoded.

15. A video decoder, the video decoder comprising:
an external memory for storing data including reference data;
a video decoder kernel coupled to the external memory to receive the reference data, wherein the video decoder kernel includes a motion compensation unit, an internal memory and a reference data fetch unit, wherein the motion compensation unit performs motion-compensated reconstruction for blocks coded in Inter prediction mode or Intra block copy mode using current reference data stored in the internal memory, and the reference data fetch unit determines whether required reference data for a current block coded in the Inter prediction mode or the Intra block copy mode are in the internal memory and fetches the current reference data from the external memory to the internal memory if the required reference data are not stored in the internal memory;
a look-ahead MV (motion vector) decoder coupled to the external memory to receive video bitstream, wherein the look-ahead MV decoder decodes motion information associated with a set of motion vectors for one or more coded blocks without storing decoded residuals associated with said one or more coded blocks, and wherein each motion vector represents displacement vector for one block coded in Inter prediction mode or Intra block copy mode, and said one or more coded blocks are coded after the current block; and
a MV analyzer unit to determine reuse information regarding reference data required for Inter prediction or Intra block copy of said one or more coded blocks based on the motion information associated with the set of motion vectors; and
wherein the video decoder is configured to cause currently decoder block to be stored in the internal memory; and
the video decoder is configured to manage the reference data in the internal memory according to the reuse information to reduce data transferring between the external memory and the internal memory.

16. The video decoder of claim 15, wherein the MV analyzer unit receives the motion information associated with the set of motion vectors for said one or more coded blocks from the look-ahead MV decoder and stores the reuse information in the external memory, and the reference data fetch unit in the video decoder kernel receives the reuse information from the external memory.

17. The video decoder of claim 15, wherein the motion information from the look-ahead MV decoder is stored in the external memory, and the MV analyzer unit receives the motion information from the external memory.

18. The video decoder of claim 17, wherein the MV analyzer unit is located within the video decoder kernel.

19. The video decoder of claim 15, further comprising a bandwidth estimation unit to estimate bandwidth required based on the reuse information for accessing the reference data from the external memory.

20. The video decoder of claim 19, wherein the bandwidth estimation unit is coupled to the MV analyzer unit to receive the reuse information directly from the MV analyzer unit.

21. The video decoder of claim 19, wherein the bandwidth estimation unit is coupled to the external memory to store information regarding estimated bandwidth required for accessing the reference data from the external memory.

22. The video decoder of claim 19, wherein the MV analyzer unit and the bandwidth estimation unit are located within the video decoder kernel.

23. A method of bandwidth estimation data for video decoding in a video decoder, the method comprising:
receiving a video bitstream corresponding to coded video data comprising a current block;
from the video bitstream, pre-decoding motion information associated with a set of motion vectors for one or more coded blocks processed after the current block without storing decoded residuals associated with said one or more coded blocks, wherein said one or more coded blocks are decoded after the current block;
determining reuse information regarding reference data required for Inter prediction for said one or more coded blocks based on the set of motion vectors;
determining estimated bandwidth required for accessing reference data from external memory based on the reuse information; and
adjusting system configurations according to the estimated bandwidth.
